(19) United States
(12) Patent Application Publication
(10) Pub. No.: US 2025/0063524 A1
(43) Pub. Date: Feb. 20, 2025

(54) MEASUREMENT REPORTING FOR PROPAGATION DELAY COMPENSATION

(71) Applicant: Telefonaktiebolaget LM Ericsson (publ), Stockholm (SE)

(72) Inventors: Zhenhua ZOU, Sollentuna (SE); Ritesh SHREEVASTAV, Upplands Väsby (SE); Mattias BERGSTRÖM, Singapore (SG)

(21) Appl. No.: 18/727,968

(22) PCT Filed: Jan. 6, 2023
(86) PCT No.: PCT/EP2023/050223

§ 371 Date: Jul. 10, 2024

Related U.S. Application Data
(60) Provisional application No. 63/298,418, filed on Jan. 11, 2022.

(51) Int. Cl. H04W 56/00; H04L 5/00; H04W 24/10

(52) U.S. Cl. CPC H04W 56/0045; H04L 5/0048; H04W 24/10; H04W 56/0015

(57) ABSTRACT

A communication device of a communications network can determine a reception-transmission (“Rx-Tx”) time difference between a pair of signals communicated with a network node of the communications network. The communication device can transmit a message to the network node, the message including an indication of the Rx-Tx time difference.

### TECHNICAL FIELD

The present disclosure is related to wireless communication systems and more particularly to measurement reporting for propagation delay compensation.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

5G system internal synchronization is described below. The use of time synchronization has been common practice for cellular networks of different generations and is an integral part of operating 5G cellular radio systems. The 5G radio network components themselves are also time synchronized (e.g., for advanced radio transmission, such as synchronized Time Division Duplex (“TDD”) operation, cooperative multipoint (“CoMP”) transmission, and carrier aggregation). The new 5G capability introduced when integrating 5G systems and time sensitive networking (“TSN”) networks is to provide 5G internal clock (reference time) delivery as a service over the 5G system (“5GS”).

In some examples, once the 5G reference time is acquired by a gNB (e.g., from a global positioning system (“GPS”)/global navigation satellite system (“GNSS”) receiver) it is sent to different nodes in the 5G network with the goal of introducing as little synchronicity error (uncertainty) as possible when distributing it.

In additional or alternative examples, the distribution of 5G reference time information to UEs is designed to exploit the existing synchronized operation inherent to the 5G radio access network.

In additional or alternative examples, a building block approach enables end-to-end time synchronization for industrial applications communication services running over 5G system.

### SUMMARY

There currently exist certain challenges. To support gNB side propagation delay compensation, the gNB needs to know the UE Rx-Tx time difference. At the gNB side, once UE Rx-Tx time difference is known, the gNB can derive the propagation delay based on the additional gNB Rx-Tx time difference measurement. The derivation of the propagation delay should also be as close as possible in time proximity to the time when the reference time is transmitted by the gNB. In LTE, UE Rx-Tx time difference report on RRC is supported since Rel-9, but the report can only be triggered periodically.

In some deployments, the gNB may periodically transmit the reference time, due to that the gNB clock is time varying and drifts. However, in the same deployment, the UE position may be stationary and there is no need for UE to send the UE Rx-Tx time difference and gNB to calculate the propagation delay all the time.

Certain aspects of the disclosure and their embodiments may provide solutions to these or other challenges. Various embodiments herein provide that a UE is configured to measure TRS/PRS that are configured by the network for the purpose of the propagation delay compensation. The measurement report contains the UE Rx-Tx time difference and the quality (e.g., RSRP) of the measurement.

According to some embodiments, a method of operating a communication device of a communications network is provided. The method includes determining a reception-transmission (“Rx-Tx”) time difference between a pair of signals communicated with a network node of the communications network. The method includes transmitting a message to the network node. The message includes an indication of the Rx-Tx time difference.

According to other embodiments, a method of operating a network node of a communications network is provided. The method includes receiving a uplink (“UL”) reference signal (“RS”) from a communication device of the communications network. The method further includes transmitting a downlink (“DL”) RS to the communication device. The method further includes determining a first reception-transmission (“Rx-Tx”) time difference indicating an amount of time between receiving the UL RS and transmitting the DL RS. The method further includes, responsive to a criteria being met, receiving a message from the communication device. The message includes an indication of a second Rx-Tx time difference indicating an amount of time between the communication device transmitting the UL RS and receiving the DL RS. The method further includes determining a propagation delay based on the first Rx-Tx and the second Rx-Tx.

According to other embodiments, a communication device, a network node, a computer program, or a computer program product is provided to perform one of the above methods.

Certain embodiments may provide one or more of the following technical advantages. In some embodiments, placing conditions on when to transmit the measurement report can reduce UE power consumption and reduce the load on the Uu interface.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a schematic diagram illustrating an example of gNB SFN Transmissions;

FIG. 3 is a diagram illustrating an example of a ReferenceTimeInfo information element (“IE”);

FIG. 4 is a table illustrating an example of ReferenceTimeInfo field descriptions;

FIG. 5 is a table illustrating an example of a time synchronization error budget for a single Uu interface;

FIG. 6 is a signal flow diagram illustrating an example of RTT-based propagation delay compensation;

FIG. 7 is a table illustrating an example of a Tₑ timing error limit;

FIG. 8 is a table illustrating an example of the value of N_{TA offset};

FIG. 9 is a table illustrating an example of T_{q} maximum autonomous time adjustment step and Tₚ minimum aggregated adjustment rate;

FIG. 10 is a diagram illustrating an example of a TimeAlignment Timer IE;

FIG. 11 is a diagram illustrating an example of a UE Rx-Tx time difference measurement in accordance with some embodiments;

FIG. 12 is a diagram illustrating an example of a NR-TimingQuality IE in accordance with some embodiments;

FIG. 13 is a table illustrating an example of NR-TimingQuality field descriptions in accordance with some embodiments;

FIG. 14 is a diagram illustrating an example of a timing quality IE for propagation delay compensation in units of nanoseconds in accordance with some embodiments;

FIG. 15 is a flow chart illustrating an example of operation performed by a communication device in accordance with some embodiments;

FIG. 16 is a flow chart illustrating an example of operation performed by a network node in accordance with some embodiments;

FIG. 17 is a block diagram of a communication system in accordance with some embodiments;

FIG. 18 is a block diagram of a user equipment in accordance with some embodiments

FIG. 19 is a block diagram of a network node in accordance with some embodiments;

FIG. 20 is a block diagram of a host computer communicating with a user equipment in accordance with some embodiments;

FIG. 21 is a block diagram of a virtualization environment in accordance with some embodiments; and

FIG. 22 is a block diagram of a host computer communicating via a base station with a user equipment over a partially wireless connection in accordance with some embodiments in accordance with some embodiments.

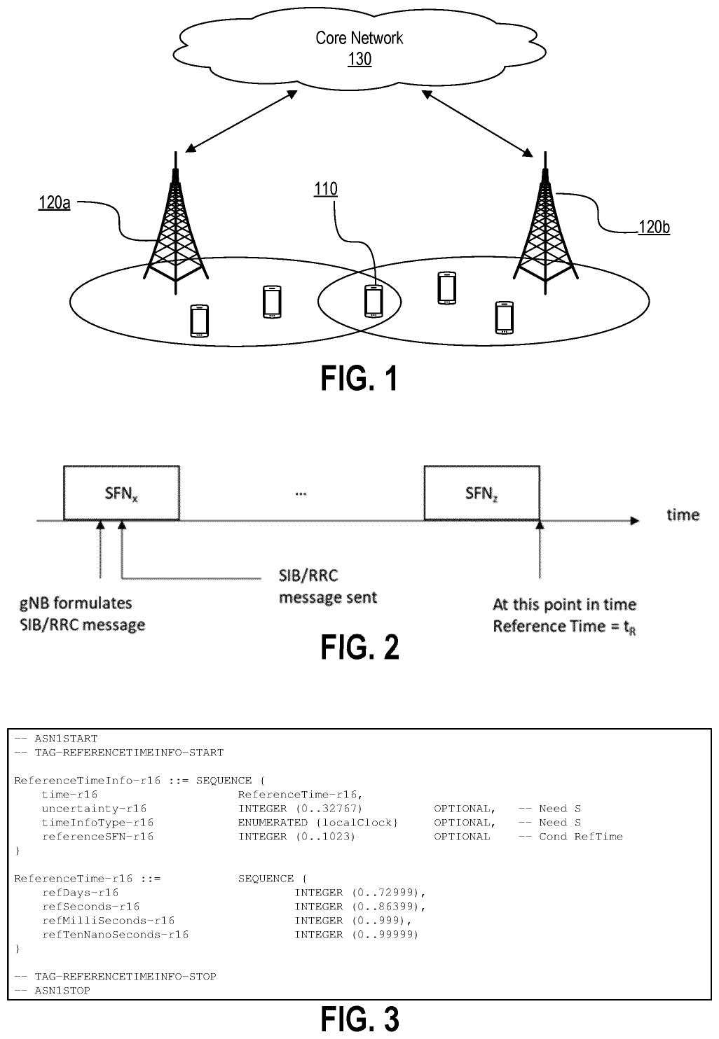

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As used herein, the term “DL reference signals” can refer to either the positioning reference signal (“PRS”) or the tracking reference signal (“TRS”) that is configured by the new radio (“NR”) base station (“gNB”) on radio resource control (“RRC”) for the purpose of propagation delay compensation.

FIG. 2 depicts an example of a gNB system frame number (“SFN”) transmissions. The gNB can maintain the acquired 5G reference time on an ongoing basis as well as periodically projecting the value it will have when a specific reference point in the system frame structure (e.g., at the end of SFN_{z}) occurs at the gNB Antenna Reference Point (“ARP”) (see reference point t_{R}).

A radio resource control (“RRC”) broadcast message (e.g., a system information block (“SIB”)) or RRC unicast message including the projected reference time value and the corresponding reference point (the value of SFN_{z}) is then transmitted during SFNₓ and received by a UE in advance of t_{R}. In some examples, it is broadcasted to all UEs in SIB9 or unicast-transmitted to individual UE in the RRC message DLInformation Transfer.

The message used to send the 5G reference time information may also include an uncertainty value to indicate to the UE the expected error (uncertainty) that the indicated 5G reference time value (applicable to the reference point t_{R}) is expected to have. In some examples, the uncertainty value reflects (a) the accuracy with which a gNB implementation can ensure that the indicated reference time corresponding to reference point t_{R} (the end of SFN_{z}) will reflect the actual time when that reference point occurs at the ARP and (b) the accuracy with which the reference time can be acquired by the gNB. In additional or alternative examples, the uncertainty introduced by (a) is implementation specific but is expected to be negligible and is therefore not further considered.

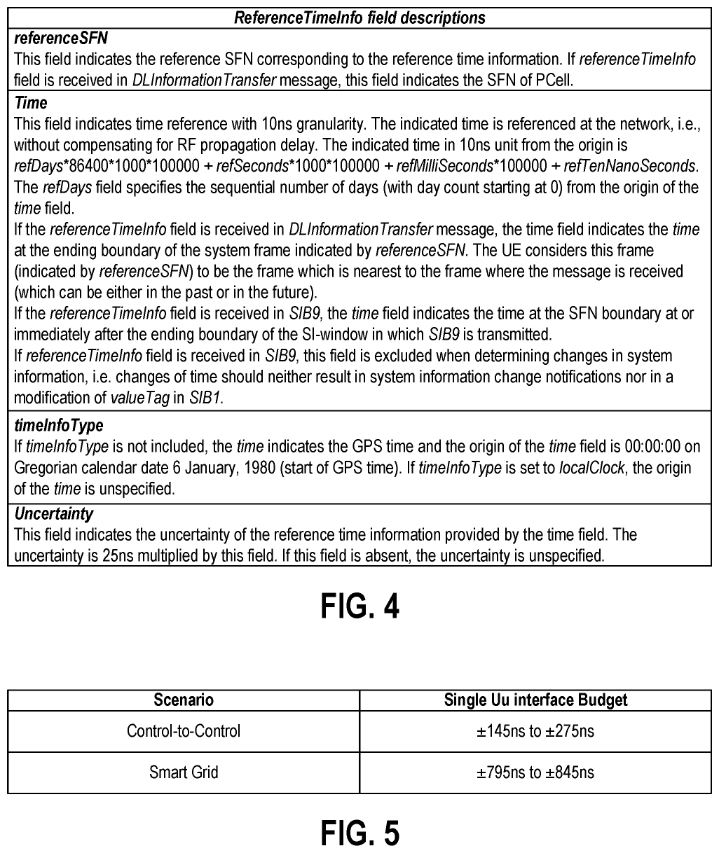

In some examples, the reference time information is transmitted in the RRC information element (“IE”), Reference TimeInfo. FIG. 3 illustrates an example of the ReferenceTimeInfo IE and FIG. 4 illustrates an example of ReferenceTimeInfo field descriptions.

Propagation delay compensation (“PDC”) to achieve very accurate reference time delivery is described below.

In an industrial example, where the provision of industrial clock synchronization service is supported through the 5G system, the 5G system is in practice only allowed to contribute a portion of the maximum end-to-end synchronicity budget (uncertainty budget) allowed for any given TSN Grandmaster clock. There are many uncertainty components in the 5G system, including the UE internal synchronization error budget, and the synchronization error budget associated with delivering the 5G internal clock to the user plane function (“UPF”) and the UE.

The biggest 5GS synchronization error introduced is when the 5G internal clock is delivered to a UE from the gNB via the Uu interface. It occurs on the air interface and is due to the error from unknown propagation delays. In some large cells, the propagation delay from the gNB to the UE can be 1 us or larger (i.e., the distance from the gNB to the UE is 300 meters or more). The range of uncertainty for the most demanding synchronization requirement for a single Uu interface shown in the table of FIG. 5 was agreed at 3GPP TSG-RAN WG2 #113-e to meet performance requirements. Two scenarios are listed to represent a general wide area deployment and a local deployment area.

In the 3^{rd} generation partnership project (“3GPP”) Rel-15/Rel-16, the legacy uplink (“UL”) transmission timing adjustment (e.g., timing advance (“TA”)) can be re-used to estimate and compensate the propagation delay. A 3GPP TA command is used in cellular communication for uplink transmission synchronization and it is an implementation variant of a Round Trip Time (“RTT”) measurement. Theoretically, the dynamic part of the TA (N_{TA}) is equal to twice the propagation delay considering the same propagation delay value applies to both downlink and uplink directions. Since the TA command is transmitted to the UE mainly via the media access control (“MAC”) control element (“CE”), the UE can derive the propagation delay. The challenges of the TA method are that due to various implementation inaccuracies in transmit timing and reception timing at gNB and UE, it introduces up-to 540 ns uncertainty to determine the downlink propagation delay on a single Uu interface based on Rel-15/Rel-16 implementation requirements, see the reference 1. Nevertheless, TA-based propagation delay compensation can meet the requirement for the smart grid scenario in FIG. 5.

In Rel-17, the radio access network (“RAN”) work item “Enhanced Industrial Internet of Things (IoT) and ultra-reliable and low latency communication (URLLC) support for NR” has introduced a propagation delay compensation procedure. The procedure includes leveraging the legacy multi-RTT positioning method. This legacy method makes use of, for example, the UE reception (“Rx”)-transmission (“Tx”) time difference measurements and DL-positioning reference signal (“PRS”)-reference signal received power (“RSRP”) of downlink signals received from multiple transmission/reception points (“TRPs”) measured by the UE, and the measured gNB Rx-Tx time difference measurements and UL-sounding reference signal (“SRS”)-RSRP at multiple TRPs of uplink signals transmitted from the UE. The measurements are used to determine the RTT at the positioning server which are used to estimate the location of the UE.

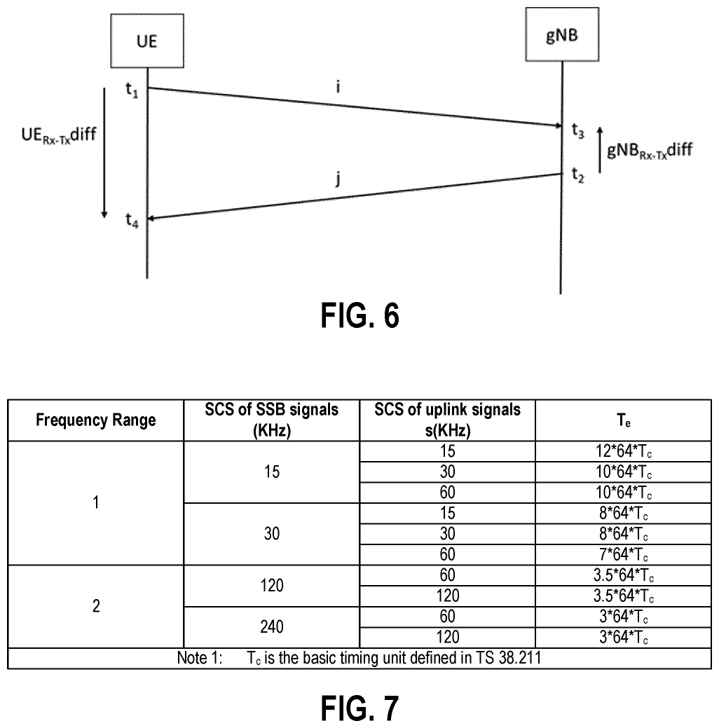

FIG. 6 illustrates an example of RTT-based propagation delay compensation. The new RTT based delay compensation method leverages the legacy multi-RTT positioning method. The UE transmits a reference signal (e.g., UL SRS) in an uplink frame i and records the transmission time as t₁. Then the gNB receives uplink frame i and records the time of arrival of the first detected path as t₃. Then the gNB transmits a reference signal (e.g., DL PRS or CSI-RS for tracking (TRS)) in a downlink frame j to the UE, and records transmission time as t₂. Then the UE receives downlink frame j and records the time of arrival of the first detected path as t₄. Then the following calculations are performed in the UE and gNB, respectively: UE_{Rx-Tx} diff=t₄−t₁ and gNB_{Rx-Tx} diff=t₃−t₂, this quantity can be positive or negative depending on the whether gNB transmits the DL frame before or after receiving the UL frame.

Then the propagation delay can be calculated as follows: Round Trip Time (RTT)=(gNB Rx-Tx time difference)+(UE Rx-Tx time difference). The propagation delay is one half of the RTT.

There are two variants of the procedure, depending on which node calculates the RTT and the other node delivers its Rx-TX difference.

In one variant, the UE-side propagation delay compensation, the gNB delivers the gNB Rx-Tx time difference to the UE and the UE calculates the round-trip time RTT to obtain the propagation delay.

In the other variant, the gNB-side propagation delay compensation, the UE delivers the UE Rx-Tx time difference to the gNB and the gNB calculates the round-trip time RTT to obtain the propagation delay.

It is discussed and further agreed in the 3GPP RANI #107e meeting: for RTT-based PDC, existing definitions of UE Rx-Tx time difference (i.e. section 5.1.30 in TS 38.215) and gNB Rx-Tx time difference (i.e. section 5.2.3 in TS 38.215) are reused, with updates at least to reflect the single pair of TRS/PRS and SRS configured for RTT-based PDC; for RTT-based PDC, it is assumed that the transmission of DL TRS/PRS, UL SRS and reference time information are associated with a same TRP; for RTT-based propagation delay compensation, the Rx-Tx time difference is reported via RRC signaling.

The need to receive time sync budget on the Uu interface is described below.

3GPP has agreed that the 5GC sends the NG-RAN “the time synchronization error budget” for Uu interface. The rationale is for the NG-RAN to appropriately configure radio resources for each UE to achieve the time synchronization error budget.

In some examples, the error budget is generally much larger than the maximum radio wave propagation delay in a cell. As a result, there is no need for NG-RAN to configure propagation delay compensation.

In additional or alternative examples, the error budget is, for example, around 500 ns or larger. As a result, the NG-RAN can configure legacy TA-based propagation delay compensation. The legacy TA-based propagation delay compensation does not require separate reference signals configurations as in the RTT-based propagation delay compensation nor any additional information exchange (as it is carried in the legacy timing advance MAC CE).

In additional or alternative examples, the error budget is, for example, below 500 ns. As a result, the NG-RAN must configure RTT-based propagation delay compensation. The more stringent the error budget is, the more radio bandwidths (e.g., more frequent reference signals, more repetitions) are needed for the reference signals used for the propagation delay compensation.

Consequently, it is specified in the TS 23.501 clause 5.27.1.9 that the AF may request to use the 5G access stratum as a time synchronization distribution method and it may include time synchronization error budget in the request. If the application function (AF) included a time synchronization error budget in the AF request, the error budget available for the NG-RAN to provide the 5GS access stratum time to each targeted UE via the Uu interface (referred to as Uu time synchronization error budget hereafter) is derived and delivered to the NG-RAN. A pre-configured time synchronization error budget is provided if the AF has not included a time synchronization error budget.

Downlink reference signals for propagation delay compensation are described below.

Both the DL PRS and the CSI-RS for tracking (also referred to herein as tracking reference signals (“TRS”)) can be used to measure the UE Rx-Tx time difference.

In NR Rel-16, the DL PRS is configured by each cell separately, and the location server (sometimes referred to herein as a location management function (“LMF”)) collects all configuration via the New Radio Positioning Protocol A (“NRPPa”), before sending an assistance data (“AD”) message to the UE via the long term evolution positioning protocol (“LPP”). In the uplink, the SRS signal is configured in RRC by the serving gNodeB, which in turn forwards appropriate SRS configuration parameters to the LMF upon request.

PRS are periodically transmitted by the gNB-distributed unit (“DU”) TRP on a positioning frequency layer (“PFL”) in PRS resources in the DL. The information about the PRS resources (e.g., PRS AD) is signaled to the UE by the positioning server (e.g., the LMF) via higher layers (e.g., via LPP). The UE uses the received PRS AD for performing one or more positioning measurements, for example, reference signal time difference (“RSTD”), PRS-RSRP, and UE Rx-Tx time difference. Each positioning frequency layer includes PRS resource sets, where each PRS resource set includes one or more PRS resources. All the DL PRS resources within one PRS resource set are configured with the same periodicity. The PRS resource periodicity (Tₚₑᵣ^{PRS}) includes:

Tₚₑᵣ^{PRS}∈2^{μ}{4, 8, 16, 32, 64, 5, 10, 20, 40, 80, 160, 320, 640, 1280, 2560, 5120, 10240, 20480} slots,

where μ=0, 1, 2, 3 for PRS SCS of 15, 30, 60 and 120 kHz respectively. Tₚₑᵣ^{PRS}=2^{μ}·20480 is not supported for μ=0.

In general, PRS resource set may comprise parameters such as subcarrier spacing (“SCS”), PRS bandwidth (“BW”), PRS resource set periodicity and slot offset with regard to reference time (e.g., SFN #0, slot #0), PRS resource repetition factor (e.g., number of times PRS resource repeated in a PRS resource set), PRS symbols in PRS resource, PRS resource time gap (e.g., number of slots between successive repetitions), and PRS muting pattern.

In general, a CSI-RS can be configured for periodic, semi-persistent, or aperiodic transmission. In the case of semi-persistent CSI-RS transmission, actual CSI-RS transmission can be activated/de-activated based on MAC CEs. Once the CSI-RS transmission has been activated, the device can assume that the CSI-RS transmission will continue according to the configured periodicity until it is explicitly de-activated. In the case of aperiodic CSI-RS, no periodicity is configured. Rather, a device is explicitly informed (“triggered”) about each CSI-RS transmission instant by means of signalling in the DCI.

Due to oscillator imperfections, the device must track and compensate for variations in time and frequency to successfully receive downlink transmissions. To assist the device in this task, a TRS can be configured. A TRS is a resource set consisting of multiple periodic non-zero-power (“NZP”)-CSI-RS. Another set of aperiodic CSI-RS resources can be configured, with the condition that the aperiodic CSI-RS and periodic CSI-RS having the same bandwidth and the aperiodic CSI-RS being “quasi-colocated (“QCL”)-TypeA” and “QCL-typeD”, where applicable, with the periodic CSI-RS resources.

The UE is configured by the network to transmit uplink frames with a ‘timing advance offset’ before the corresponding downlink frame within a certain uplink transmission time error margin. Due to the drift of the UE clock also the uplink frame timing relative to the downlink frame timing will drift. When the difference compared to the configured ‘timing advance offset’ becomes too large it has to be adjusted. When and how an NR UE should do such timing adjustments is described below. These UE timing adjustments can have impact on UE RX-TX time difference measurements. The N_{TA} can refer to a timing offset between uplink and downlink radio frames at the UE. The N_{TA offset} can refer to a fixed timing advance offset. T_{c} can refer to a Basic time unit.

The UE can be capable of following the frame timing change of the reference cell in a connected state. The uplink frame transmission takes place (N_{TA}+N_{TA offset})×T_{c} before the reception of the first detected path (in time) of the corresponding downlink frame from the reference cell. For serving cell(s) in primary timing advance group (“PTAG”), UE shall use the special cell (“SpCell”) as the reference cell for deriving the UE transmit timing for cells in the PTAG. For serving cell(s) in secondary timing advance group (“STAG”), UE shall use any of the activated secondary cells (“SCells”) as the reference cell for deriving the UE transmit timing for the cells in the STAG. UE initial transmit timing accuracy, maximum amount of timing change in one adjustment, minimum and maximum adjustment rate are defined by a series of requirements.

In some examples, the requirements include that the UE initial transmission timing error shall be less than or equal to ±Tₑ. FIG. 7 illustrates the timing error limit value Tₑ. When it is the first transmission in a discontinuous reception (“DRX”) cycle for a physical uplink control channel (“PUCCH”), physical uplink shared channel (“PUSCH”), and SRS or it is the physical random access channel (“PRACH”) transmission.

In additional or alternative examples, the UE shall meet the Te requirement for an initial transmission provided that at least one synchronization signal block (“SSB”) is available at the UE during the last 160 ms. The reference point for the UE initial transmit timing control requirement shall be the downlink timing of the reference cell minus (N_{TA}+N_{TA offset})×T_{c}. The downlink timing is defined as the time when the first detected path (in time) of the corresponding downlink frame is received from the reference cell. N_{TA} for PRACH is defined as 0.

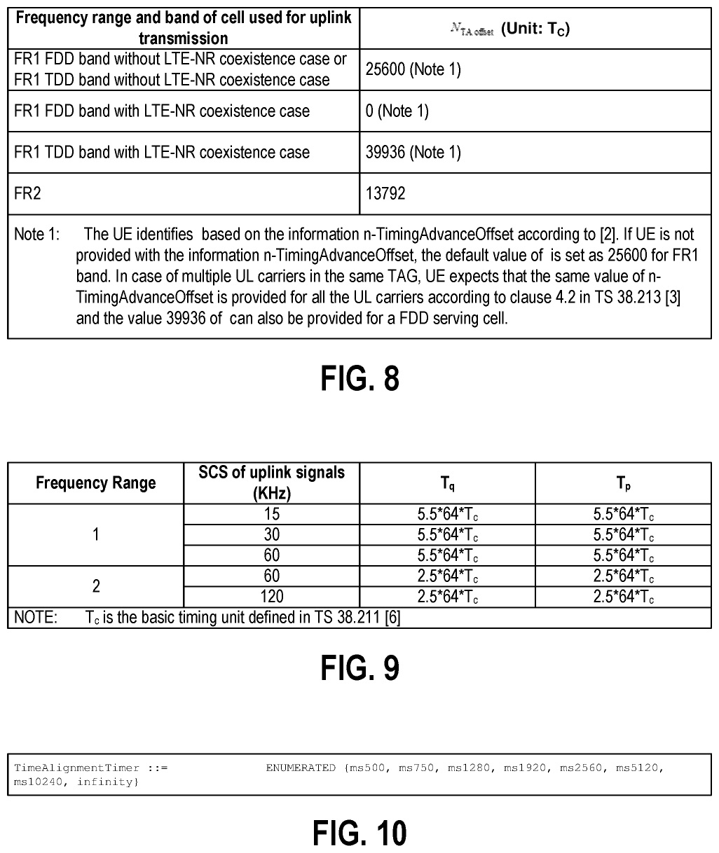

(N_{TA}+N_{TA offset})×T_{c} (in T_{c} units) for other channels is the difference between UE transmission timing and the downlink timing immediately after when the last timing advance was applied. N_{TA} for other channels is not changed until next timing advance is received. The value of N_{TA offset} can depends on the duplex mode of the cell in which the uplink transmission takes place and the frequency range (FR). N_{TA offset} is defined in the table of FIG. 8

In additional or alternative examples, when it is not the first transmission in a DRX cycle or there is no DRX cycle, and when it is the transmission for PUCCH, PUSCH and SRS transmission, the UE shall be capable of changing the transmission timing according to the received downlink frame of the reference cell except when the timing advance is applied.

When the transmission timing error between the UE and the reference timing exceeds ±Tₑ then the UE is required to adjust its timing to within ±Tₑ. The reference timing shall be (N_{TA}+N_{TA offset})×T_{c} before the downlink timing of the reference cell. All adjustments made to the UE uplink timing shall follow these rules: (1) The maximum amount of the magnitude of the timing change in one adjustment shall be T_{q}; (2) The minimum aggregate adjustment rate shall be Tₚ per second; and (3) The maximum aggregate adjustment rate shall be T_{q} per 200 ms. The maximum autonomous time adjustment step T_{q} and the aggregate adjustment rate Tₚ are specified in FIG. 9.

FIG. 10 illustrates an example of a TimeAlignmentTimer IE that is used to control how long the UE considers the serving cells belonging to the associated TAG to be uplink time aligned.

Certain aspects of the disclosure and their embodiments may provide solutions to these or other challenges. Various embodiments herein provide that a UE is configured to measure TRS/PRS that are configured by the network for the purpose of the propagation delay compensation. The measurement report contains the UE Rx-Tx time difference and the quality (e.g., RSRP) of the measurement.

In some embodiments, the measurement report is triggered by the first time the measurement is configured and later triggered by that the difference between the current UE Rx-Tx time difference and a previous UE Rx-Tx time difference is larger than a threshold.

In additional or alternative embodiments, the measurement report is triggered whenever there is a TRS/PRS transmission from the network.

In additional or alternative embodiments, the measurement report is triggered whenever UE obtains a new Timing advance command.

In additional or alternative embodiments, the measurement report is triggered whenever UE performs (gradual) timing adjustment. In some examples, when the transmission timing error between the UE and the reference timing exceeds ±Tₑ then the UE is required to adjust its timing to within ±Tₑ.

In additional or alternative embodiments, the measurement report is triggered, whenever UE RSRP value is outside a range (e.g., the NW configures an RSRP threshold range (min, max)) and the UE reports the UE Rx-Tx.

In additional or alternative embodiments, the measurement report is triggered, after start, restart, or expiration of a timing alignment timer. In additional or alternative embodiments, the UE starts, restarts, or detects the expiration of the timing alignment timer in response to receiving a PDCCH order.

In additional or alternative embodiments, the measurement report is triggered after detecting a failure event (e.g., a radio link failure).

In additional or alternative embodiments, the measurement report is transmitted to the NW in response to a criteria being met and the measurement report includes a UE Rx-Tx measurement.

Certain embodiments may provide one or more of the following technical advantages. In some embodiments, placing conditions on when to transmit the measurement report can reduce UE power consumption and reduce the load on the Uu interface.

In some embodiments, a measurement is reported on the RRC by the communication device (also referred to herein as a user equipment (“UE”)) whenever there is a downlink (“DL”) reference signal transmitted from the gNB. In some examples, the gNB periodically transmits the reference time to correct the accumulated time shift due to unavoidable clock drifts at the UE or at the gNB. In this periodic reference time delivery, the gNB must know beforehand the up-to-date propagation delay between the UE and the gNB. In additional or alternative examples, periodic DL reference signals are configured before the gNB's expected periodic reference time delivery. In these examples, the gNB may acquire the measurement as soon as it is ready on the UE side. Even though the main target case is the periodic DL reference signals, the network may also trigger aperiodic DL reference signals (e.g., aperiodic channel state information reference signals (“CSI-RS”) for tracking). In these examples, the UE can report on the RRC whenever there are aperiodic DL reference signals triggered.

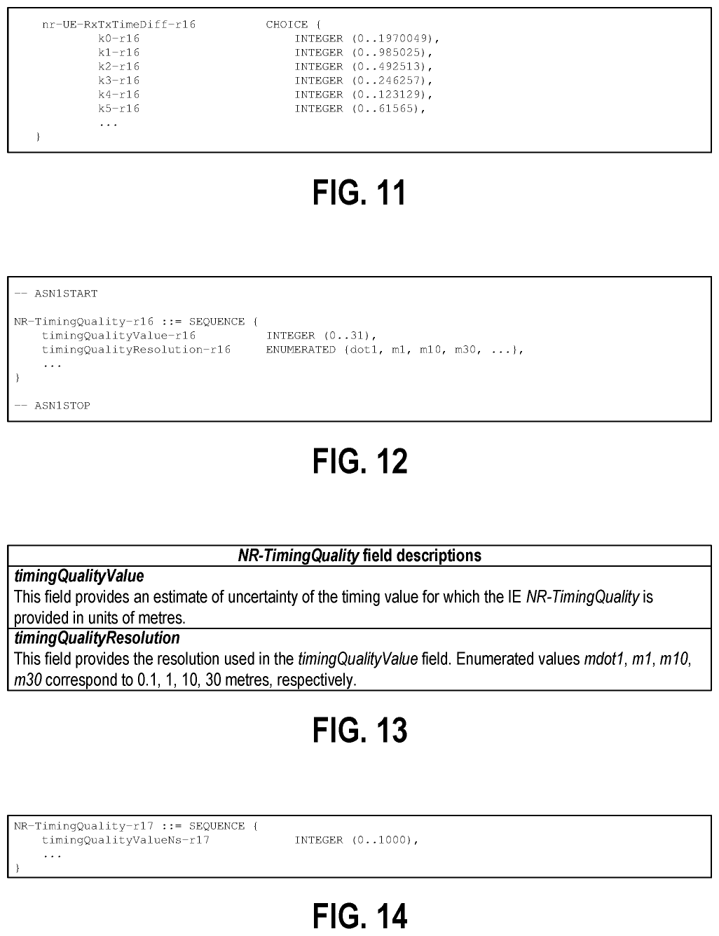

In additional or alternative embodiments, a measurement is reported on the RRC by the UE based on a set of conditions/events. In some examples, a first condition includes the difference between the current UE reception (“Rx”)-transmission (“Tx”) time difference and the previous reported UE Rx-Tx time difference being larger than a threshold. FIG. 11 illustrates an example of the NR UE Rx-Tx time difference measurement represented by a set of integer values, as in the long term evolution (“LTE”) positioning protocol (“LPP”).

In some embodiments, the threshold is a RRC configurable integer number. If the absolute value of the difference is larger than this threshold, then a measurement is reported. The UE may have skipped multiple measurement reports and so it is important to compare with the measurement that has been reported to the gNB. For example, suppose the UE reports at time t₁ measurement m₁ but skips reporting the measurement m₂ at time t₂. At time t₃, the UE must compare m₃ with m₁ (instead of m₂) to check if the absolute difference is larger than the threshold or not. The reason is that the network is not aware of the exact value of m₂, because it is not reported by the UE.

In additional or alternative embodiments, the threshold is configured in a way so that the measurement is always reported (e.g., the threshold has a value smaller than zero).

In additional or alternative examples, a second condition includes that it is the first time the measurement reporting is (re)-configured by the gNB and the first time measurement report is available.

In some embodiments, reporting only when a set of conditions/events are met can reduce RRC signalling overhead since the gNB can assume that the UE Rx-Tx time difference is the same as the previous reported value.

In additional or alternative embodiments, a measurement is reported on the RRC by the UE if the reference signals received power (“RSRP”), reference signals received quality (“RSRQ”), or signal-to-interference-and-noise ratio (“SINR”) satisfies a certain condition (e.g., it is below a configurable value, or outside a configurable range of minimum and maximum RSRP/RSRQ/SINR values). The reference signals can be either PRS or CSI-RS for tracking. This is an additional triggering compared to the one described above.

In additional or alternative embodiments, a measurement is reported on the RRC by the UE if a timing quality of the measurement is below a configurable value. This is an additional triggering compared to the ones described above.

The NR UE Rx-Tx time difference measurement can be associated with a quality of the measurement, represented by the NR-TimingQuality IE in FIG. 12. FIG. 13 illustrates an example of NR-Timing Quality field descriptions.

In a similar fashion, FIG. 14 illustrates an example of a timing quality for propagation delay compensation in units of nanoseconds. The field timingQuality ValueNs-r17provides an estimate of uncertainty of the timing value for which the IE NR-TimingQuality is provided in units of nanoseconds. The resolution is assumed to be 10 nanoseconds, so that for an integer i, the uncertainty is 10*i nanoseconds. If the timingQuality ValueNs-r17 is larger than a RRC configurable integer, then a measurement is reported. This means that the quality of the measurement is lower than a configured value, and it is important to let the gNB be aware of this by reporting this measurement.

In some embodiments, the network may trigger the aperiodic CSI-RS for tracking by a DCI command. Such an aperiodic CSI-RS for tracking is triggered, for example, to allow more sample points for UE Rx-Tx time difference measurements. This can be a result of that the previous UE Rx-Tx Time difference has an unsatisfactory quality or the UE's Uu interface sync error budget has been tightened or become more stringent. The UE's Uu interface sync error budget can become more stringent, if the UE has moved/associated with another gNB, and leads to that the routing path between the UE and the UPF has changed with, for example, one more gPTP hop (consuming 40 ns synchronization budget). In this scenario, the DL periodic reference signals can be PRS and CSI-RS for tracking.

In additional or alternative embodiments, the measurement is still reported only after a periodic transmission instance of the DL reference signals (either periodic PRS or periodic CSI-RS for tracking). In this embodiment, the UE additionally measures the UE Rx-Tx time difference of aperiodic triggered CSI-RS for tracking between the previous periodic DL reference signal transmissions and the current periodic DL reference signal transmissions. The UE report all measurements or report an average of these measurements.

In additional or alternative embodiments, the UE may only report the measurement if it satisfies a set of conditions/events. For example, if the absolute value of the difference between the average of the UE Rx-Tx time difference measurements and the previous reported measurement is larger than a threshold, then the UE report the UE Rx-Tx time difference measurements.

In additional or alternative embodiments, the UE triggers the reporting using the conditions on RSRP/RSRQ/SINR, timing quality as described in the previous embodiments. The measurements of RSRP/RSRQ/SINR, timing quality are averaged between the previous periodic DL reference signals transmissions and the current periodic DL reference signal transmissions.

In additional or alternative embodiments, the UE measures the DL reference signals between two periodic DL reference signal transmissions. This is equivalent to that an evaluation duration of reference signals equal to the periodicity of the DL reference signals. In one follow-up embodiment, the UE evaluates the DL reference signals (e.g., the Rx-Tx time difference, RSRP/RSRQ/SINR, timing quality) by a configurable evaluation period. The duration is configurable by the gNB and typically larger than the periodicity of DL reference signals. The UE can only report the measurement after the evaluation duration, in addition to the conditions described in the above embodiments.

In additional or alternative embodiments, any timing adjustment that UE may have to perform can trigger reporting UE Rx-Tx. The timing adjustment made by UE is a notification that UE progradation distance may have shifted and UE then needs to report the new measurement. The timing adjustment can be the gradual timing adjustment or the timing adjustment upon receiving a timing advance MAC CE or timing advance command in a random access response message. However, gNB may also provide the ranges or thresholds upon which the UE may be allowed to send (e.g., for gradual timing advancement adjustment); i.e a relaxed criterion may also be provided so that UE does not need to report this too frequently in some environment where the TA adjustments need to be performed very rapidly.

In additional or alternative embodiments, whenever UE TA timer starts, restarts (after expiry), after receiving the timing advance MAC CE, the UE may report UE Rx-Tx. Another related condition is that after TA alignment timer expiry; UE is considered to be out of synch in UL; and hence when it receives a PDCCH order from the gNB; it resynchronizes; and as part of this procedure, it is claimed that UE shall trigger UE Rx-Tx measurement report.

In some examples, the triggering of the UE reporting of Rx-Tx measurement means that the UE shall report UE Rx-Tx measurement when receiving the next DL references and measuring the UE Rx-Tx measurement.

In additional or alternative examples, the triggering of the UE reporting of Rx-Tx measurement means that the UE shall report UE Rx-Tx measurement immediately after the triggering. In the report, the UE adjusts a previous UE Rx-Tx measurement with the relevant timing advance changes and transmits this adjusted measurement. In the report, the UE can also directly indicates the timing advancing change and a previous un-adjusted UE Rx-Tx measurement.

In additional or alternative embodiments, the UE shall report UE Rx-Tx after failure event such as radio link failure. The UE loses the synchronization and reestablishes again and as part of this procedure, UE reports the UE Rx-Tx measurement.

In some embodiments, the measurement report is triggered if any one, a combination, or all of the conditions are met. In some examples, a condition related with RSRP/RSRQ/SINR is met or a condition related to Rx-Tx Time difference is met. In additional or alternative examples, the measurement report is triggered if both the condition related with RSRP/RSRQ/SINR is met and the condition related to Rx-Tx Time difference is met.

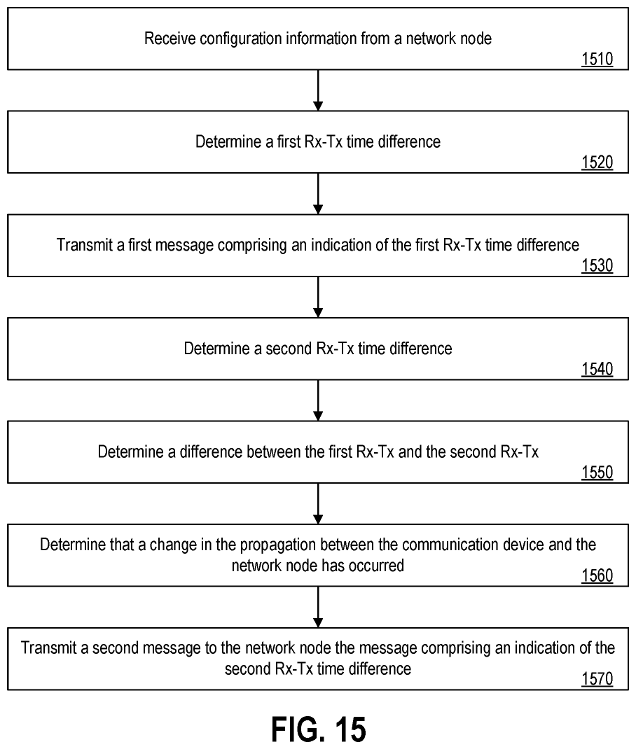

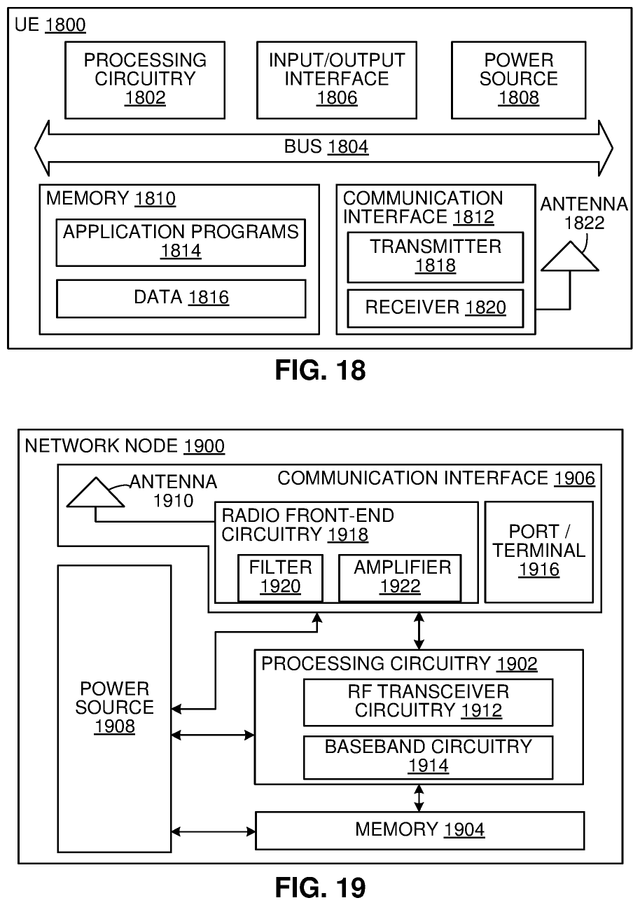

In the description that follows, while the communication device may be any of UE 1712A-D, 1800, hardware 2104, or virtual machine 2108A, 2108B, the communication device 1800 shall be used to describe the functionality of the operations of the communication device. Operations of the communication device 1800 (implemented using the structure of FIG. 18) will now be discussed with reference to the flow chart of FIG. 15 according to some embodiments of inventive concepts. For example, modules may be stored in memory 1810 of FIG. 18, and these modules may provide instructions so that when the instructions of a module are executed by respective communication device processing circuitry 1802, processing circuitry 1802 performs respective operations of the flow chart.

FIG. 15 illustrates operations performed by a communication device of a communications network.

At block 1510, processing circuitry 1802 receives, via communication interface 212, configuration information from a network node. In some examples, the configuration information includes: a request to configure the communication device to measure a reference signal transmitted by the network node; a request to transmit the message; and an indication of when to transmit the message. In additional or alternative examples, the reference signal includes at least one of a tracking reference signal, TRS; and a positioning reference signal, PRS.

At block 1520, processing circuitry 1802 determines a first Rx-Tx time difference. In some examples, the Rx-Tx time difference is an amount of time between a pair of signals communicated with the network node.

At block 1530, processing circuitry 1802 transmits, via communication interface 21, a first message comprising an indication of the first Rx-Tx time difference. In some examples, the first message is a measurement report including a quality of a measurement of the reference signal.

At block 1540, processing circuitry 1802 determines a second Rx-Tx time difference.

At block 1550, processing circuitry 1802 determines a difference between the first Rx-Tx and the second Rx-Tx.

At block 1560, processing circuitry 1802 determines that a change in the propagation delay between the communication device and the network node has occurred. In some embodiments, determining that the change in the propagation delay has occurred includes determining that the difference between the first Rx-Tx and the second Rx-Tx exceeds a threshold value.

In additional or alternative embodiments, determining that the change in propagation delay has occurred includes the communication device obtaining a new timing advance command.

In additional or alternative embodiments, determining that the change in propagation delay has occurred includes the communication device performing a timing adjustment. In some examples, performing the timing adjustment includes performing the timing adjustment in response to determining that a transmission timing error between the communication device and the network node exceeds a threshold value.

In additional or alternative embodiments, determining that the change in propagation delay has occurred includes determining that a characteristic of a reference signal is outside a predetermined range. In some examples, the characteristic includes at least one of: a reference signal received power, RSRP; a reference signal received quality, RSRQ; and a signal-to-interference-and-noise ratio, SINR.

In additional or alternative embodiments, determining that the change in propagation delay has occurred includes at least one of starting a timing alignment timer; restarting a timing alignment timer; and detecting expiration of a timing alignment timer.

In additional or alternative embodiments, determining that the change in propagation delay has occurred includes determining a failure event has occurred (e.g., a radio link failure).

In additional or alternative embodiments, determining that the change in the propagation delay has occurred includes receiving an indication of the change in the propagation delay from the network node.

At block 1570, processing circuitry 1802 transmits, via communication interface 1812, a second message to the network node, the message including an indication of the second Rx-Tx time difference.

In additional or alternative embodiments, the Rx-Tx time difference includes a communication device Rx-Tx time difference indicating an amount of time between the communication device transmitting a first signal to the network node and the communication device receiving a second signal from the network node.

Various operations of FIG. 15 may be optional with respect to some embodiments. For example, in regards to some embodiments, blocks 1510, 1520, 1530, 1550, and 1560 may be optional.

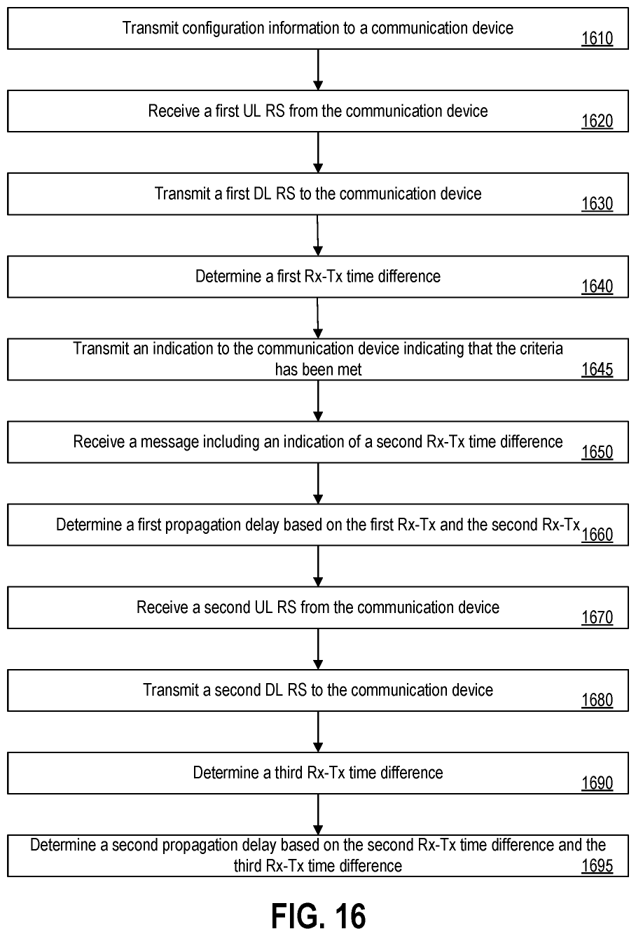

In the description that follows, while the network nodes may be any of the network node 1710A, 1710B, 1900, 2206, hardware 2104, or virtual machine 2108A, 2108B, the network node 1900 shall be used to describe the functionality of the operations of the network nodes. Operations of the network node 1900 (implemented using the structure of FIG. 19) will now be discussed with reference to the flow charts of FIG. 16 according to some embodiments of inventive concepts. For example, modules may be stored in memory 1904 of FIG. 19, and these modules may provide instructions so that when the instructions of a module are executed by respective network node processing circuitry 1902, processing circuitry 1902 performs respective operations of the flow charts.

FIG. 16 illustrates an example of operations performed by a network node in a communications network.

At block 1610, processing circuitry 1902 transmits, via communication interface 1906, configuration information to a communication device. In some embodiments, the configuration information includes a request to configure the communication device to transmit the UL RS to the network node; a request to measure the DL RS transmitted by the network node; a request to transmit the message to the network node; and an indication of when to transmit the message to the network node.

At block 1620, processing circuitry 1902 receives, via communication interface 1906, receives a first UL RS from the communication device.

At block 1630, processing circuitry 1902 transmits, via communication interface 1906, transmits a first DL RS to the communication device.

At block 1640, processing circuitry 1902 determines a first Rx-Tx time difference.

At block 1645, processing circuitry 1902 transmits, via communication interface 1906, an indication to the communication device indicating that the criteria has been met.

At block 1650, processing circuitry 1902 receives, via communication interface 1906, a message including an indication of a second Rx-Tx time difference. In some embodiments, the message is received in response to a criteria being met. In some examples, the criteria includes the communication device having not previously provided a Rx-Tx time difference to the network node. In additional or alternative examples, the message is a measurement report including a quality of a measurement of the DL RS.

In additional or alternative examples, the criteria includes a change in propagation delay associated with communications between the communication device and the network node. The change in the propagation delay can include: a difference in the second Rx-Tx time difference and a previously reported Rx-Tx time difference exceeding a threshold value; the communication device obtaining a timing advance command; the communication device performing a timing adjustment; a characteristic of a RS being outside a predetermined range; the communication device starting a timing alignment timer; restarting a timing alignment timer; or detecting expiration of a timing alignment timer; and a radio link failure between the communication device and the network node. The characteristic of the RS can include at least one of: a reference signal received power, RSRP; a reference signal received quality, RSRQ; and a signal-to-interference-and-noise ratio, SINR.

At block 1660, processing circuitry 1902 determines a first propagation delay based on the first Rx-Tx and the second Rx-Tx.

At block 1670, processing circuitry 1902 receives, via communication interface 1906, a second UL RS from the communication device.

At block 1680, processing circuitry 1902 transmits, via communication interface 1906, a second DL RS to the communication device.

At block 1690, processing circuitry 1902 determines a third Rx-Tx time difference.

At block 1695, processing circuitry 1902 determines a second propagation delay based on the second Rx-Tx time difference and the third Rx-Tx time difference. In some embodiments, The second propagation delay is determined based on the second Rx-Tx in response to a predetermined period of time elapsing without receiving a second message from the communication device including an indication of a fourth Rx-Tx time difference indicating an amount of time between the communication device transmitting the second UL RS and receiving the second DL RS. In some examples, the second Rx-Tx time difference is determined to be within a threshold value of the fourth Rx-Tx based on the UE not providing a message indicating the fourth Rx-Tx.

In some embodiments, the UL RS and the DL RS each include at least one of a tracking reference signal, TRS; and a positioning reference signal, PRS.

Various operations of FIG. 16 may be optional with respect to some embodiments. For example, in regards to some embodiments, blocks 1610, 1645, 1670, 1680, 1690, and 1695 may be optional.

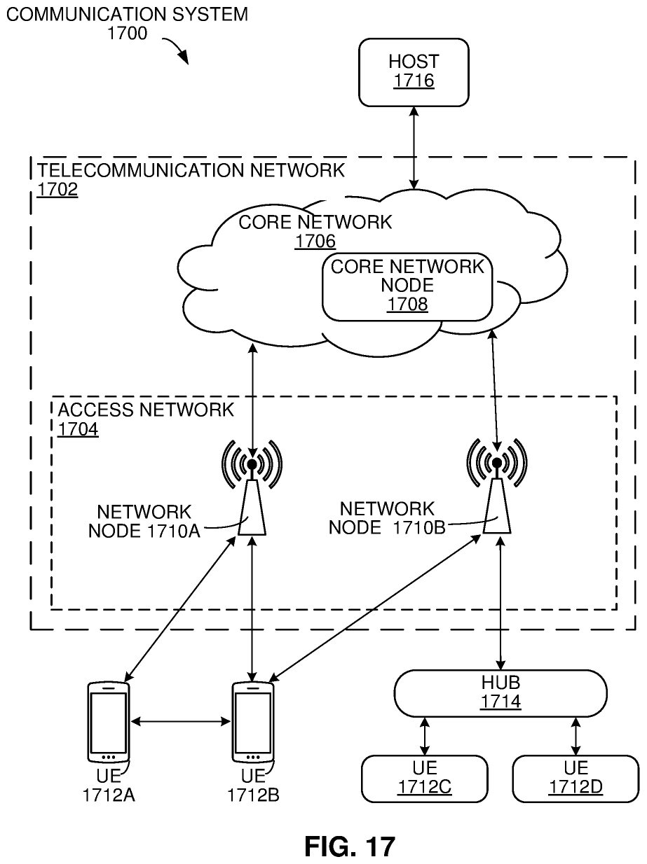

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3^{rd} Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

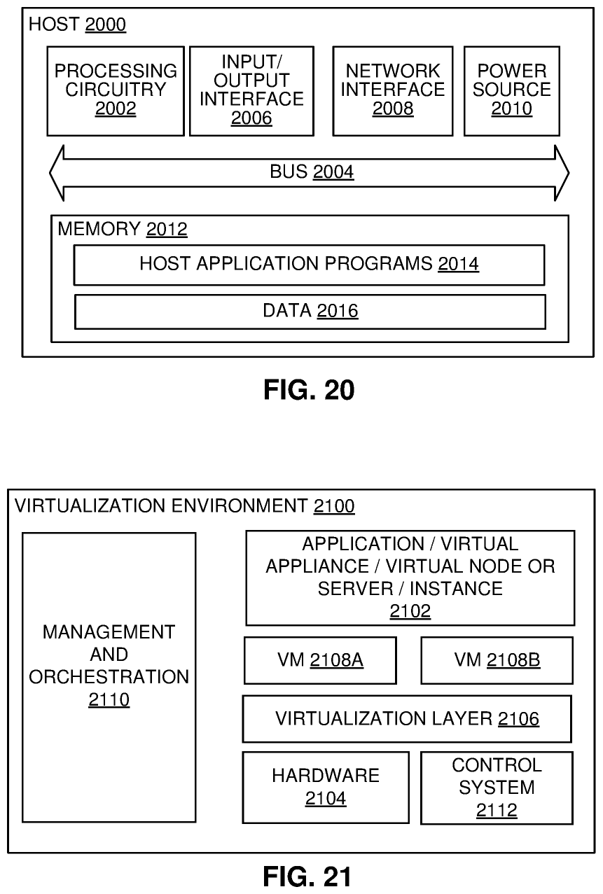

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

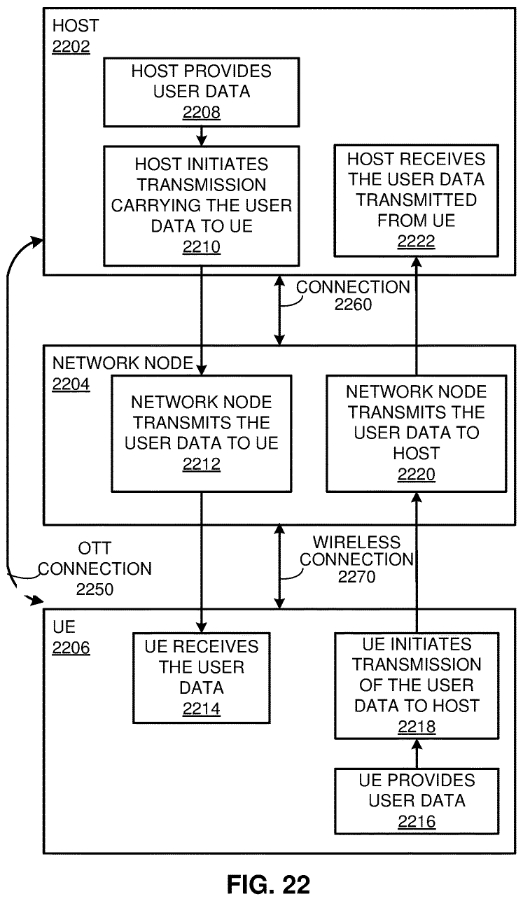

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment. More precisely, the teachings of these embodiments may allow a multinode cloud-based system (e.g., a FaaS system) to schedule functions based on requirements of the function and a status of the cloud-based system, and thereby ensure E2E RT runtimes for RT functions.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a communication device of a communications network, the method comprising:
determining a reception-transmission, Rx-Tx, time difference between a pair of signals communicated with a network node of the communications network; and
transmitting a message to the network node, the message comprising an indication of the Rx-Tx time difference.

2. The method of claim 1, further comprising:
receiving an aperiodic tracking reference signal, TRS,
wherein transmitting the message comprises transmitting the message in response to receiving the aperiodic TRS.

3. The method of claim 2, wherein the pair of signals comprise the aperiodic TRS and an uplink signal transmitted by the communication device.

4. The method of claim 1, wherein transmitting the message comprises transmitting the message in response to a change in propagation delay associated with communications between the communication device and the network node,

5. The method of claim 4, further comprising:
determining that the change in the propagation delay has occurred.

6. The method of claim 5, wherein the Rx-Tx time difference is a second Rx-Tx time difference between a second pair of signals communicated with the network node,
wherein the message comprises a second message,
the method further comprising:
determining a first Rx-Tx time difference between a first pair of signals communicated with the network node;
transmitting a first message comprising an indication of the first Rx-Tx time difference; and
determining a difference between the first Rx-Tx and the second Rx-Tx,
wherein determining that the change in the propagation delay has occurred comprises determining that the difference between the first Rx-Tx and the second Rx-Tx exceeds a threshold value.

7. The method of claim 5, wherein determining that the change in propagation delay has occurred comprises at least one of:
the communication device obtaining a timing advance command;
the communication device performing a timing adjustment;
determining that a characteristic of a reference signal is outside a predetermined range starting a timing alignment timer;
restarting a timing alignment timer;
detecting expiration of a timing alignment timer;
determining a failure event
determining a radio link failure; and
receiving an indication of the change in the propagation delay from the network node.

8. The method of claim 7, wherein determining that the change in propagation delay has occurred comprises the communication device performing a timing adjustment, and
wherein performing the timing adjustment comprises performing the timing adjustment in response to determining that a transmission timing error between the communication device and the network node exceeds a threshold value.

9. The method of claim 7, wherein determining that the change in propagation delay has occurred comprises determining that a characteristic of a reference signal is outside a predetermined range, and
wherein the characteristic comprises at least one of: a reference signal received power, RSRP; a reference signal received quality, RSRQ; and a signal-to-interference-and-noise ratio, SINR.

10. The method of claim 1, further comprising:
receiving configuration information from the network node, the configuration information comprising:
a request to configure the communication device to measure a reference signal transmitted by the network node;
a request to transmit the message; and
an indication of when to transmit the message.

11. The method of claim 10, wherein the reference signal comprises at least one of a tracking reference signal, TRS; and a positioning reference signal, PRS, and
wherein the message is a measurement report comprising a quality of a measurement of the reference signal.

12. The method of claim 1, wherein the Rx-Tx time difference comprises a communication device Rx-Tx time difference indicating an amount of time between the communication device transmitting a first signal to the network node and the communication device receiving a second signal from the network node.

13. A method of operating a network node of a communications network, the method comprising:
receiving a uplink, UL, reference signal, RS, from a communication device of the communications network;
transmitting a downlink, DL, RS to the communication device;
determining a first reception-transmission, Rx-Tx, time difference indicating an amount of time between receiving the UL RS and transmitting the DL RS;
responsive to a criteria being met, receiving a message from the communication device, the message comprising an indication of a second Rx-Tx time difference indicating an amount of time between the communication device transmitting the UL RS and receiving the DL RS; and
determining a propagation delay based on the first Rx-Tx and the second Rx-Tx.

14. The method of claim 13, wherein transmitting the DL RS comprises transmitting an aperiodic tracking reference signal, TRS, and
wherein the criteria comprises the DL RS being the aperiodic TRS.

15. The method of claim 13, wherein the UL RS comprises a first UL RS,
wherein the DL RS comprises a second DL RS,
wherein the propagation delay comprises a first propagation delay,
the method further comprising:
receiving a second UL RS from the communication device;
transmitting a second DL RS to the communication device;
determining a third Rx-Tx time difference indicating an amount of time between receiving the second UL RS and transmitting the second DL RS; and
responsive to a predetermined period of time elapsing without receiving a second message from the communication device comprising an indication of a fourth Rx-Tx time difference indicating an amount of time between the communication device transmitting the second UL RS and receiving the second DL RS, determining a second propagation delay based on the second Rx-Tx time difference and the third Rx-Tx time difference.

16. The method of claim 13, wherein the criteria comprises the communication device having not previously provided a Rx-Tx time difference to the network node.

17. The method of claim 13, wherein the criteria comprises a change in propagation delay associated with communications between the communication device and the network node.

18. The method of claim 17, wherein the change in the propagation delay comprises:
a difference in the second Rx-Tx time difference and a previously reported Rx-Tx time difference exceeding a threshold value;
the communication device obtaining a timing advance command;
the communication device performing a timing adjustment;
a characteristic of a RS being outside a predetermined range;
the communication device starting a timing alignment timer, restarting a timing alignment timer, or detecting expiration of a timing alignment timer; and
a radio link failure between the communication device and the network node.

19. The method of claim 18, wherein the characteristic of the RS comprises at least one of: a reference signal received power, RSRP; a reference signal received quality, RSRQ; and a signal-to-interference-and-noise ratio, SINR.

20. The method of claim 13, further comprising:
transmitting an indication to the communication device indicating that the criteria has been met

21. The method of claim 13, further comprising:
transmitting configuration information to the communication device, the configuration information comprising:
a request to configure the communication device to transmit the UL RS to the network node;
a request to measure the DL RS transmitted by the network node;
a request to transmit the message to the network node; and
an indication of when to transmit the message to the network node.

22. The method of claim 13, wherein the UL RS and the DL RS each comprise at least one of a tracking reference signal, TRS; and a positioning reference signal, PRS, and
wherein the message is a measurement report comprising a quality of a measurement of the DL RS.

23. A communication device operating in a communications network, the communication device adapted to perform operations comprising any of the operations of claims 1.

24.-25. (canceled)

26. A network node operating in a communications network, the network node adapted to perform operations comprising any of the operations of claims 13.

27.-28. (canceled)
